(19) United States
(12) Patent Application Publication
(10) Pub. No.: US 2025/0182952 A1
(43) Pub. Date: Jun. 5, 2025

(54) COIL DEVICE

(71) Applicant: TAI-TECH ADVANCED ELECTRONICS CO., LTD., Taoyuan City (TW)

(72) Inventors: Ming-Yen Hsieh, Taoyuan City (TW); Pao-Lin Shen, Taoyuan City (TW); Hsiang-Chung Yang, Taoyuan City (TW); Jian-Hong Lai, Taoyuan City (TW); Kuan-Yi Lu, Taoyuan City (TW)

(21) Appl. No.: 18/525,810

(22) Filed: Nov. 30, 2023

(51) Int. Cl. H01F 27/28; H01F 27/24

(52) U.S. Cl. CPC H01F 27/28; H01F 27/24

(57) ABSTRACT

A coil device includes a core having a central pillar and two rims located on two sides of the central pillar; a first conductor disposed in an interior of the core and including a first body portion and two first mounting portions that are respectively formed on two sides of the first body portion, lengths of the first mounting portions being greater than or equal to widths of the rims to allow the two first mounting portions to each expose outside of the core; a second conductor disposed in an interior of the first conductor and including a second body portion and two second mounting portions that respectively formed on two sides of the second body portion, the second conductor including a retention portion in retaining engagement with the central pillar; and an insulation layer arranged between the first conductor and the second conductor.

### BACKGROUND OF THE INVENTION

### (a) Technical Field of the Invention

The present invention relates to a coil device, and more particularly to a coil device for serving as an electrical inductor.

### (b) Description of the Prior Art

A coil device generally includes a core and two conductors. The conductors are arranged inside the core so that an area between the two conductors that has no magnetic elements arranged therein can enhance the magnetic coupling between the two conductors.

Taiwan Patent I786632 provides a coil device that includes a first conductor, a second conductor arranged inside of the first conductor and at least partly extending along the first conductor, and a core having an interior in which the first conductor and the second conductor are arranged, and an insulation layer is formed between at least the first conductor and the second conductor.

However, in the prior art, referring to FIG. 1A of I786632, a length of mounting portions is less than a width of outer leg portions and the core is exposed outside of the mounting portions. Since the length of the mounting portions is relatively small, a contact area between the mounting portions and a circuit board is limited and an area for soldering is limited and the soldering strength is limited, so that there is still room for improvement. Further, the second conductor is arranged on the periphery of a first central leg portion (second central leg portion), but there is no fixing structure arranged between the second conductor and the first central leg portion (second central leg portion), so that during application of an adhesive agent to fix the second conductor on the first core, the second conductor may get vibrated, making it hard to accurately position the second conductor at a designated location, and consequently, mass productivity is poor.

### SUMMARY OF THE INVENTION

To achieve the above objective, the present invention provides a coil device, which comprises: a core, which comprises a central pillar and two rims located on two sides of the central pillar; a first conductor, which is disposed in an interior of the core, the first conductor comprising a first body portion and two first mounting portions, the two first mounting portions being respectively formed at two sides of the first body portion, the first mounting portions having lengths that are greater than or equal to widths of the rims so as to allow the two first mounting portions to each expose outside of the core; a second conductor, which is disposed in an interior of the first conductor, the second conductor comprising a second body portion and two second mounting portions, the two second mounting portions being respectively formed at two sides of the second body portion, the second conductor comprising a retention portion, the retention portion being set in retaining engagement with the central pillar; and an insulation layer, which is arranged between the first conductor and the second conductor.

In the above device, the core is provided with an insulative coating layer.

In the above device, the first conductor comprises a conductor plate having a coating layer.

In the above device, the first conductor comprises two outer curved portions that are curved in an outward direction, and the outer curved portions are located between the first body portion and the first mounting portions.

In the above device, the second conductor comprises two inner curved portions that are curved in an inward direction, and the inner curved portions are located between the second body portion and the second mounting portions.

In the above device, the second conductor is formed of a flattened wire.

In the above device, the insulation layer comprises an insulative covering film formed on a surface of the second conductor.

In the above device, the retention portion comprises an M-shaped configuration.

In the above device, the retention portion comprises a W-shaped configuration.

By setting the lengths of the first mounting portions to be greater than or equal to the widths of the rims, the two first mounting portions are each exposed outside of the core to increase a contact area of the first mounting portions with the circuit board for increasing a soldering area and thus enhancing soldering strength. Further, by setting the retention portion in retaining engagement with the central pillar, the first conductor and the second conductor are securely retained and fixed in the interior of the core.

### BRIEF DESCRIPTION OF THE DRAWINGS

FIG. 1 is a perspective view showing a coil device of the present invention.

FIG. 2 is a top plan view showing the coil device of the present invention.

FIG. 3 is an exploded view showing the coil device of the present invention.

FIG. 4 is a schematic view showing a retention portion according to the present invention formed as an M-shape.

FIG. 5 is a schematic view showing a retention portion according to the present invention formed as a W-shape.

### DETAILED DESCRIPTION OF THE PREFERRED EMBODIMENTS

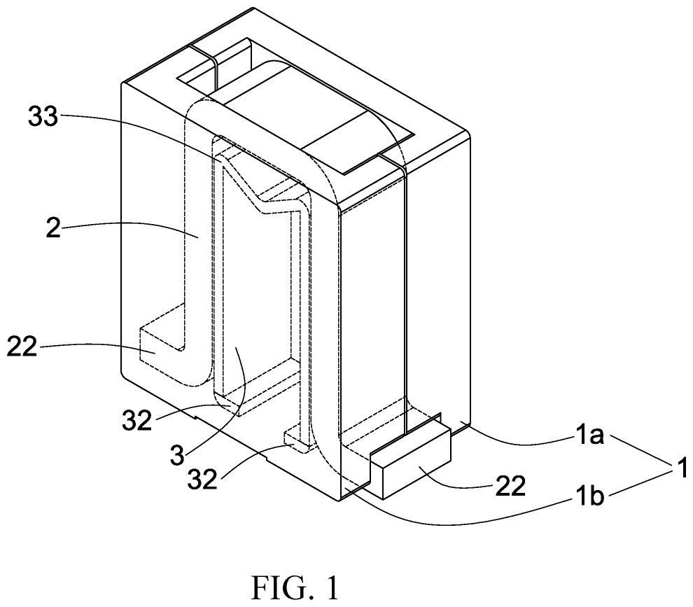

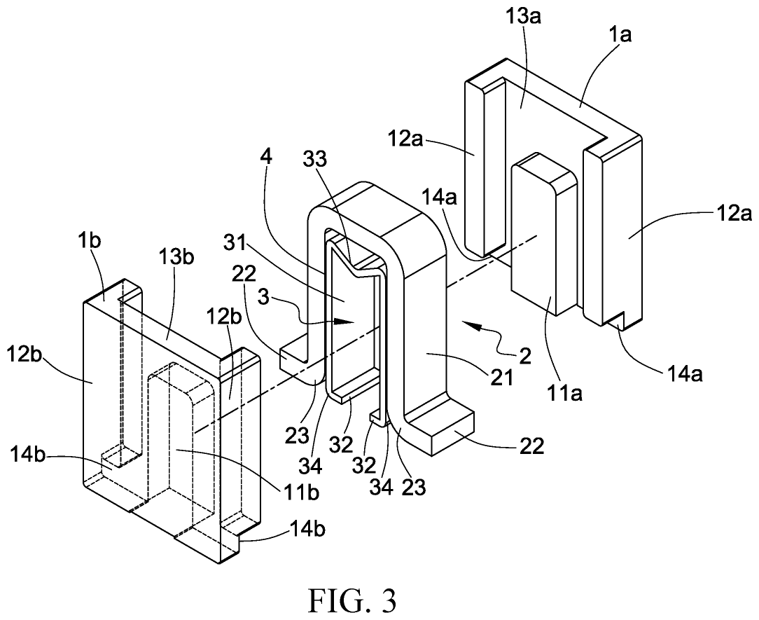

Referring to FIGS. 1 and 3, the present invention provides a coil device, which comprises: a core 1, a first conductor 2, a second conductor 3, and an insulation layer 4. Either one of the first conductor 2 and the second conductor 3 functionally serves as a primary winding, while the other one functionally serves as a secondary winding.

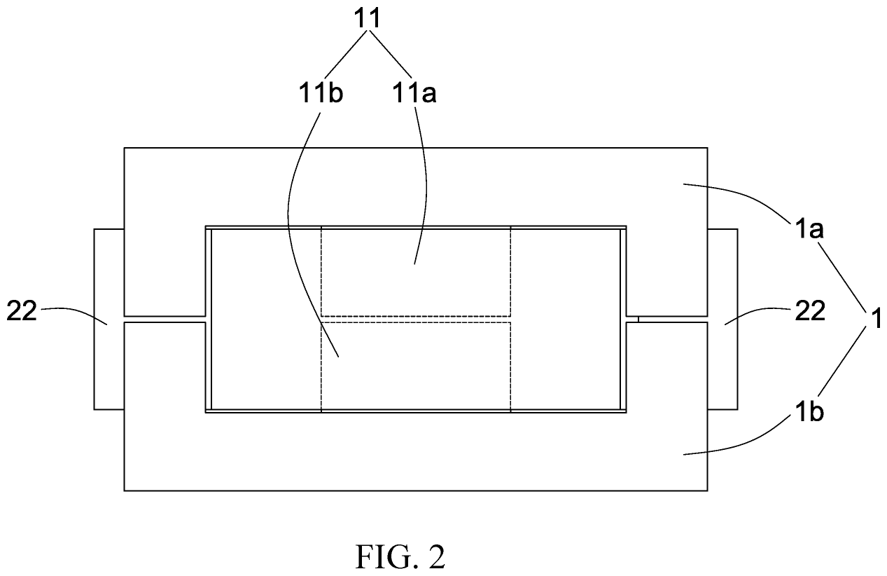

Referring to FIGS. 1, 2, and 3, the core 1 comprises a central pillar 11 and two rims 12 located on two sides of the central pillar 11. Specifically speaking, the core 1 is formed of a magnetic object, such as a magnetic object including Ni—Zn series ferrite, Mn—Zn series ferrite, or metallic magnet members. The core 1 may comprises a first core 1a and a second core 1b bonded together by means of for example an adhesive agent. The first core 1a and the second core 1b are of the same shape, which is an E-shape. The first core 1a is provided with a first central pillar 11a, two first rims 12a, a first recessed portion 13a, and two first rectangular notch portions 14a. The first central pillar 11a is arranged at a center of the first core 1a. The two first rims 12a are respectively fixed to, in a manner of being spaced from each other, to two sides of the first core 1a. The first recessed portion 13a is formed on a periphery of the first central pillar 11a. The two first rectangular notch portions 14a are respectively formed in the two first rims 12a at one side thereof. Similarly, the second core 1b is provided with a second central pillar 11b, two second rims 12b, a second recessed portion 13b, and two second rectangular notch portions 14b. The second central pillar 11b is arranged at a center of the second core 1b. The two second rims 12b are respectively fixed to, in a manner of being spaced from each other, to two sides of the second core 1b. The second recessed portion 13b is formed on a periphery of the second central pillar 11b. The two second rectangular notch portions 14b are respectively formed in the two second rims 12b at one side thereof. In other words, when the first core 1a and the second core 1b are adhesively bonded together, the first central pillar 11a and the second central pillar 11b jointly form the central pillar 11; the first rims 12a and the second rims 12b jointly form the rims 12; the first recessed portion 13a, the first rectangular notch portions 14a, the second recessed portion 13b, and the second rectangular notch portions 14b jointly define a recessed trough for accommodating the first conductor 2 and the second conductor 3.

The first conductor 2 is disposed in an interior of the core 1. The first conductor 2 comprises a first body portion 21 and two first mounting portions 22. The two first mounting portions 22 are respectively formed on two sides of the first body portion 21. Further, lengths of the first mounting portions 22 are greater than or equal to widths of the rims 12, so that the two first mounting portions 22 are exposed outside of the core 1. Specifically speaking, examples of materials making the first conductor 2 include good conductors, such as metals including copper and copper alloys, silver, and nickel, but not limited thereto. The first conductor 2 can be a conductor plate having a coating layer and is formed in a curved configuration having a U-shape. The two first mounting portions 22 are provided for connecting with a circuit board, and solder (or electrically conductive adhesive) can be used to solder (or adhere) the two first mounting portions 22 to the circuit board 5. The core 1 can be provided with an insulative coating layer 15. The insulative coating layer 15 is formed of a resinous material, such as epoxy resin or polyurethane resin. The insulative coating layer 15 is formed on a bottom surface of the central pillar 11 (namely the first central pillar 11a and the second central pillar 11b).

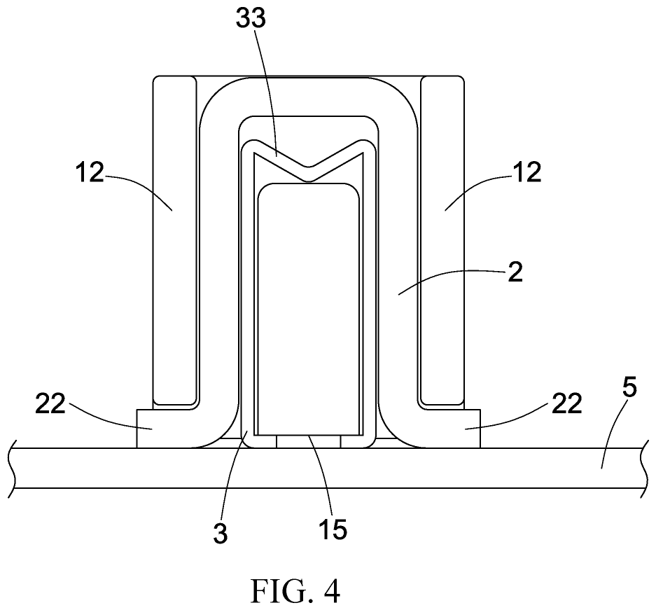

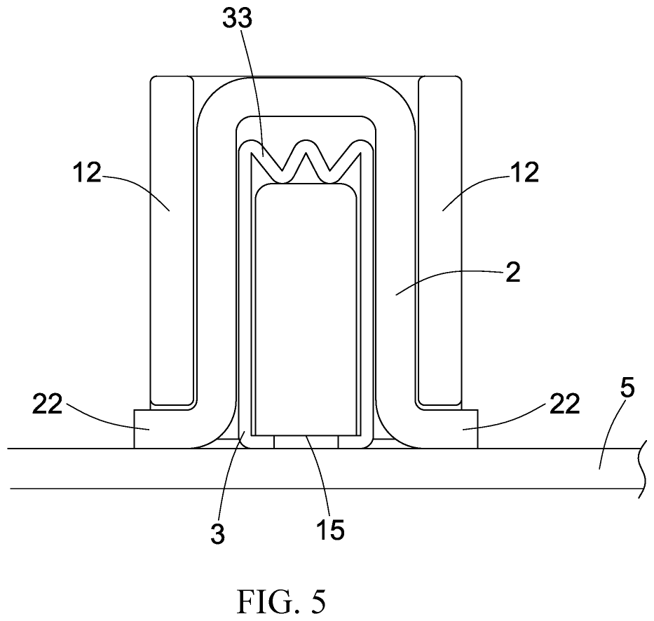

The second conductor 3 is disposed in an interior of the first conductor 2. The second conductor 3 comprises a second body portion 31 and two second mounting portions 32. The two second mounting portions 32 are respectively formed on two sides of the second body portion 31. Further, the second conductor 3 comprises a retention portion 33, and the retention portion 33 is set in retaining engagement with the central pillar 11. The second conductor 3 is formed of a flattened wire and is formed in a curved configuration having a U-shape. The second conductor 3 can be made of a material that is the same as that of the first conductor 2. The first conductor 2 and the second conductor 3 are both disposed in the interior of the core 1, such that the second conductor 3 is arranged in the interior of the first conductor 2 in a manner of being mutually spaced from each other and the central pillar 11 (which is jointly formed of the first central pillar 11a and the second central pillar 11b) is located in an interior of the second conductor 3, and the two rims 12 (which is jointly formed of the first rims 12a and the second rims 12b) are located outside of the first conductor 2. The first conductor 2 is provided with two outer curved portions 23 that are curved in an outward direction, and the outer curved portions 23 are located between the first body portion 21 and the first mounting portions 22, respectively. The second conductor 3 is provided with two inner curved portions 34 that are curved in an inward direction, and the inner curved portions 34 are located between the second body portion 31 and the second mounting portions 32, respectively. Referring to FIGS. 4 and 5, the retention portion 33 can be of an M-shape configuration, or the retention portion 33 can be of a W-shaped configuration.

Continuing to refer to FIGS. 1, 2, and 3, the insulation layer 4 is arranged between the first conductor 2 and the second conductor 3. The insulation layer 4 can be an insulative covering film formed on a surface of the second conductor 3.

By setting the lengths of the first mounting portions 22 to be greater than or equal to the widths of the rims 12, the two first mounting portions 22 are each exposed outside of the core 1 to increase a contact area of the first mounting portions 22 with the circuit board 5 for increasing a soldering area and thus enhancing soldering strength. Further, by setting the retention portion 33 in retaining engagement with the central pillar 11, the first conductor 2 and the second conductor 3 are securely retained and fixed in the interior of the core 1, so that during application of an adhesive agent to fix the second conductor 3 to the first core 1a, no vibration of the second conductor 3 will occur and the second conductor 3 can be easily and accurately positioned on a designated location to thereby improve mass productivity thereof.

I claim:

1. A coil device, comprising:
a core, which comprises a central pillar and two rims located on two sides of the central pillar;
a first conductor, which is disposed in an interior of the core, the first conductor comprising a first body portion and two first mounting portions, the two first mounting portions being respectively formed at two sides of the first body portion, the first mounting portions having lengths that are greater than or equal to widths of the rims so as to allow the two first mounting portions to each expose outside of the core;
a second conductor, which is disposed in an interior of the first conductor, the second conductor comprising a second body portion and two second mounting portions, the two second mounting portions being respectively formed at two sides of the second body portion, the second conductor comprising a retention portion, the retention portion being set in retaining engagement with the central pillar; and
an insulation layer, which is arranged between the first conductor and the second conductor.

2. The coil device according to claim 1, wherein the core is provided with an insulative coating layer.

3. The coil device according to claim 1, wherein the first conductor comprises a conductor plate having a coating layer.

4. The coil device according to claim 1, wherein the first conductor comprises two outer curved portions that are curved in an outward direction, and the outer curved portions are located between the first body portion and the first mounting portions.

5. The coil device according to claim 1, wherein the second conductor comprises two inner curved portions that are curved in an inward direction, and the inner curved portions are located between the second body portion and the second mounting portions.

6. The coil device according to claim 1, wherein the second conductor is formed of a flattened wire.

7. The coil device according to claim 1, wherein the insulation layer comprises an insulative covering film formed on a surface of the second conductor.

8. The coil device according to claim 1, wherein the retention portion comprises an M-shaped configuration.

9. The coil device according to claim 1, wherein the retention portion comprises a W-shaped configuration.
